(19) United States
(12) Patent Application Publication
(10) Pub. No.: US 2013/0037238 A1
(43) Pub. Date: Feb. 14, 2013

(54) FASTENERS AND HEAT DISSIPATION DEVICES WITH THE FASTENERS

(71) Applicants: Xiang-Yang YANG, Shenzhen City (CN); Jing ZHANG, Shenzhen City (CN)

(72) Inventors: Xiang-Yang YANG, Shenzhen City (CN); Jing ZHANG, Shenzhen City (CN)

(73) Assignees: Foxconn Technology Co., Ltd., Tu-Cheng (TW); Fu Zhun Precision Industry (Shen Zhen) Co., Ltd., Shenzhen City (CN)

(21) Appl. No.: 13/284,960

(22) Filed: Oct. 30, 2011

(30) Foreign Application Priority Data
Aug. 9, 2011 (CN) 201110226842.5

(51) Int. Cl. F28F 9/007; F16B 23/00; F16B 27/00

(52) U.S. Cl. 165/67; 411/347

(57) ABSTRACT

A fastener for fixing heat dissipation devices includes a shaft, a cap and an elastic member. The shaft includes a first end, an opposite second end, and a flange between the first and second ends. The cap is detachably engaged with the second end of the shaft. The elastic member partly encloses the shaft, and is retained between the flange and the cap. A heat dissipation device matching with the fastener is also provided.

### BACKGROUND

1. Technical Field

The present disclosure generally relates to fixing apparatus, and particular to fasteners for fixing heat dissipation devices. Heat dissipation devices using the fasteners are also provided.

2. Description of Related Art

During operation of electronic devices such as computer central processing units (CPUs), north bridges and south bridges, for example, a large amount of heat is often produced. The heat must be quickly removed from the electronic devices to prevent them from overheating and being damaged. Many heat dissipation devices are attached to an outer surface of the electronic device to absorb the heat from the CPU, and fasteners usually fix the heat dissipation device. This can be unreliable and inconvenient for installation and removal.

Therefore, it is necessary to provide a kind of fastener for fixing the heat dissipation device, with satisfied reliability and convenient disassembly process.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic view of a heat dissipation device fixed with fasteners in accordance with the present disclosure.

FIG. 2 is a partially exploded view of the heat dissipation device and the accompanying fasteners of FIG. 1.

FIG. 3 is an exploded view of one of the fasteners of FIG. 1.

FIG. 4 is a schematic assembly view of one of the fasteners of FIG. 1 fixing the heat dissipation device.

### DETAILED DESCRIPTION

Reference will now be made to the drawings to describe the present fastener, in detail.

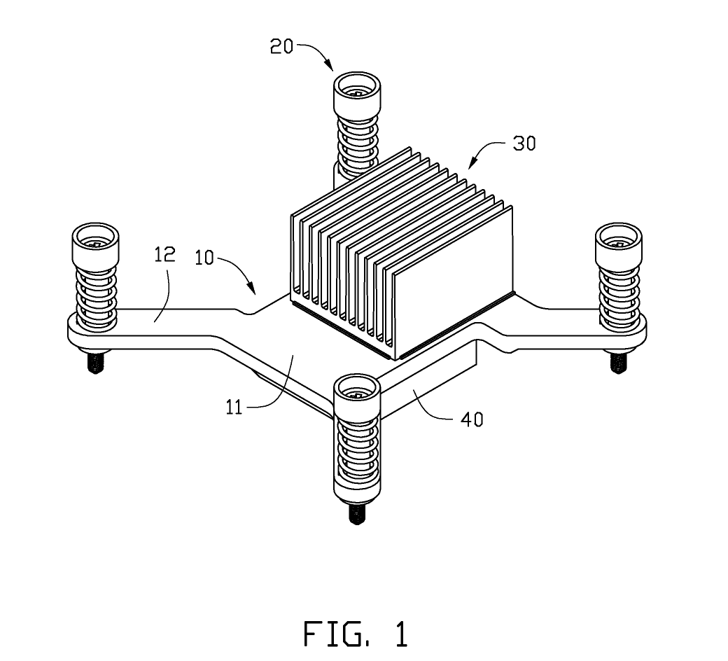

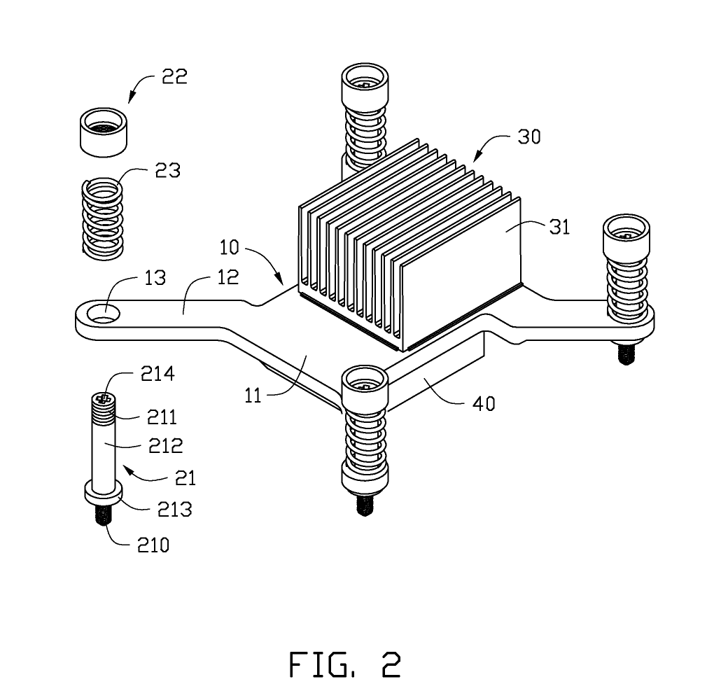

Referring to FIG. 1 and FIG. 2, fasteners 20 according to an exemplary embodiment of present disclosure are provided together with a heat sink 30, and a supporter 10 supporting the heat sink 30.

The supporter 10 includes a main body 11, and four protrusions 12. In this embodiment, the main body 11 is a rectangular plate, the four protrusions 12 extend slantwise respectively from four corners of the main body 11. The supporter 10 has its bottom surface attached to a heat conducting plate 40, which is used for contacting heat generating components (not illustrated). The supporter 10 has its upper surface attached to the heat sink 30. The four protrusions 12 each have a strip configuration with a through hole 13 defined at a distal end thereof.

The heat sink 30 includes a plurality of fins 31 parallel to each other.

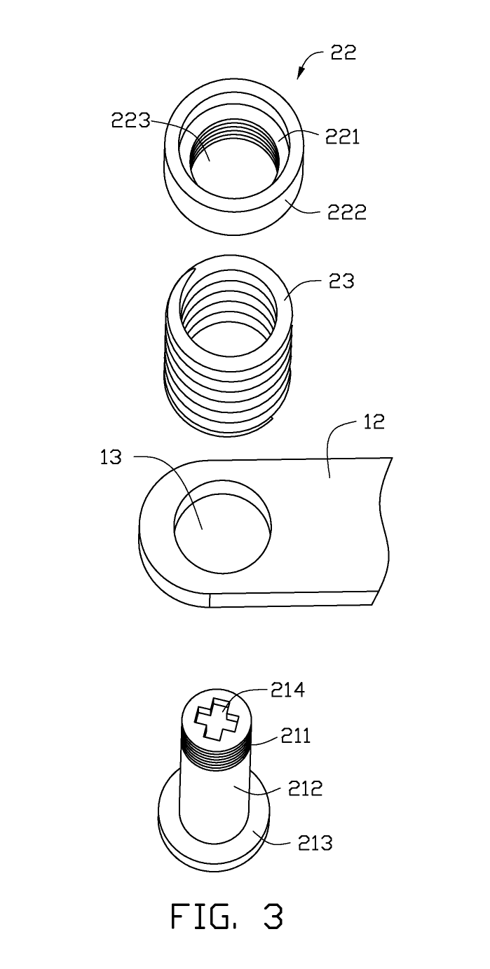

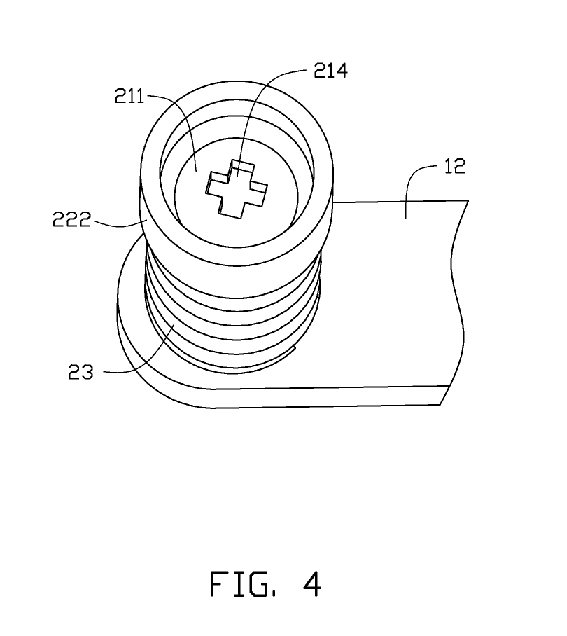

Also referring to FIG. 3 and FIG. 4, each of the fasteners 20 includes a shaft 21, a screw cap 22 and an elastic member 23 partly enclosing the shaft 21.

The shaft 21 includes a first thread end 210, a second thread end 211 opposite to the first thread end 210, and a middle portion 212 interconnecting the first thread end 210 and the second thread end 211.

The first thread end 210 has a cylindrical configuration with threads formed on an outer sidewall.

The middle portion 212 has a cylindrical configuration. An annular flange 213 protruding from a peripheral sidewall of the shaft 21, at a joint of the middle portion 212 and the first thread end 210. The annular flange 213 has an outer diameter larger than a diameter of the through hole 13.

The second thread end 211 has a cylindrical configuration with threads formed on an outer sidewall. In a further embodiment, the second thread end 211 further includes Phillips head 214 at a free end surface. As such, Phillips screwdrivers can turn the shaft 21. Accordingly, the first thread end 210 of the shaft 21 can be assembled into a threaded hole on circuit boards (not illustrated).

The screw cap 22 includes an annular engaging portion 221 and a barrel portion 222 surrounding the engaging portion 221. In this embodiment, the engaging portion 221 and the barrel portion 222 are integrally made from one piece of member.

The engaging portion 221 includes a through hole 223 defined at a center thereof. The through hole 223 has threads formed on an inner sidewall. As such, the second thread end 211 can be threaded with the engaging portion 221.

The barrel portion 222 extends from a peripheral circumference of the engaging portion 221, along a longitudinal direction of the annular engaging portion 221 and away from the middle portion 212. An end part of the barrel portion 222 extends beyond the engaging portion 221 to form a sleeve at an end of the engaging portion 221. The sleeve has an internal diameter equal to an external diameter of the engaging portion 221.

The elastic member 23 can be a helical spring. The elastic member 23 has an inner diameter larger than a diameter of the middle portion 212. The elastic member 23 has an outer diameter smaller than that of the barrel portion 222.

When the fastener 20 is fixed to the heat supporter 10, the second thread end 211 and the middle portion 212 is arranged to upwardly penetrate the through hole 13 of the protrusion 12. Due to the flange 213 having an outer diameter larger than a diameter of the through hole 13, the first thread end 210 will be retained at a bottom side of the main body 11, while the second thread end 211 and the middle portion 212 at a top side of the main body 11. The elastic member 23 encloses the middle portion 212 at the top side of the main body 11. A bottom end of the elastic member 23 rests on the top of the protrusion 12. The engaging portion 221 is engaged with the second thread end 211, thus, the fastener 20 is retained with the supporter 10. Due to the elastic member 23 having an outer diameter smaller than that of the barrel portion 222, a top end of the elastic member 23 is blocked under the bottom of the screw cap 22. As such, the elastic member 23 is retained between the supporter 10 and the screw cap 22.

When the fastener 20 is employed to fix the supporter 10 on a circuit board with heat generating components, the first thread end 210 of the fastener 20 is screwed into the circuit board or a back plate attached to the circuit board, by a screwdriver operating the Phillips head 214 of the fastener 20. Therefore, the supporter 10 is fixed on the circuit board, with the heat conducting plate 40 contacting heat generating components equipped on the circuit board.

In the embodiment, the barrel portion 222 encloses the Phillips head 214 of the second thread end 211, thereby protecting the Phillips head 214 from damage by external force, and preventing a head of the screwdriver from sliding away from the fastener 20 when the screwdriver operates the fastener 20. The engaging portion 221 can also screws toward or away from the middle portion 212 to adjust a compression length of the elastic member 23 to adjust an elastic force on the supporter 10 toward the circuit board.

When there is any requirement to detached the heat sink 30, the screw cap 22 can be twisted off the second thread end 211, and the supporter 10 with the heat sink 30 arranged thereon can be picked up after removing the elastic member 23 without detaching the fasteners 20 engaged on the circuit board. The disassembly process of the heat sink 30 is convenient.

It is to be noted that, the first thread end 210 can be configured with other engaging structures rather than threads, as long as it is capable being fixed to a circuit boards. The second thread end 211 can also be configured with other engaging structures rather than threads, as long as capable of detachably being engaged with the screw cap 22. The main body 11 of the supporter 10 can be configured with other shapes, and the number of the protrusions 12 of the supporter 10 is also not limited to four.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A fastener for fixing heat dissipation devices comprising:
a shaft having a first end, an opposite second end, and a flange between the first and second ends;
a cap detachably engaged with the second end of the shaft; and
an elastic member for enclosing a part of the shaft between the flange and the cap.

2. The fastener according to claim 1, wherein the second end has threads formed thereon, and the cap is a screw cap capable of being engaged with the second end by threads.

3. The fastener according to claim 2, wherein the screw cap comprises an annular engaging portion with a through thread hole defined at a central thereof.

4. The fastener according to claim 3, wherein the screw cap comprises a barrel portion extends from a peripheral circumference of the engaging portion and surrounding the engaging portion.

5. The fastener according to claim 4, wherein the barrel portion extends along a longitudinal direction of the annular engaging portion.

6. The fastener according to claim 5, wherein the barrel portion has an end part extending beyond the barrel portion along the longitudinal direction of the annular engaging portion.

7. The fastener according to claim 4, wherein the elastic member has an outer diameter smaller than that of the barrel portion.

8. The fastener according to claim 1, wherein the first end is a cylinder portion has threads formed thereon.

9. The fastener according to claim 1, wherein the shaft further comprises a middle portion interconnecting the first and second ends, the elastic member enclosing the middle portion of the shaft.

10. The fastener according to claim 1, wherein the second end has Phillips head defined on an end surface thereof.

11. A heat dissipation device comprising:
a supporter with a plurality of through holes defined therein;
a heat sink arranged on the supporter; and
a plurality of fasteners each comprising:
a shaft having a first end, an opposite second end, and a flange between the first and second ends, the first end and the flange of the shaft of the fastener being retained at a bottom side of the supporter, and the second end of the shaft penetrating through a corresponding through hole to a top side of the heat sink, the first end of the fastener being for engaging with a circuit board;
a cap detachably engaged with the second end of the shaft; and
an elastic member retained between the supporter and the cap and enclosing a part of the shaft between the supporter and the cap.

12. The heat dissipation device according to claim 11, wherein the supporter comprises a main body and a plurality of protrusions extending from the main body, the heat sink being arranged on the main body, the plurality of through holes being defined on the protrusions.

13. The heat dissipation device according to claim 11, wherein the flange of each fastener has an annular shape with an outer diameter larger than a diameter of the through hole.

14. The heat dissipation device according to claim 11, wherein the cap comprises an engaging portion detachably engaged with the second end of the shaft and a barrel portion surrounding the engaging portion.

15. The heat dissipation device according to claim 14, wherein the barrel portion has an end part extending beyond the engaging portion along a longitudinal direction of the engaging portion.

16. The heat dissipation device according to claim 15, wherein the barrel portion encloses the second end of the shaft.
